(19) United States
(12) Patent Application Publication
(10) Pub. No.: US 2016/0079670 A1
(43) Pub. Date: Mar. 17, 2016

(54) WIRELESS ELECTRONIC DEVICES INCLUDING FLEXIBLE MAGNETIC MATERIAL THAT EXTENDS THROUGH OPENINGS OF A PRINTED CIRCUIT BOARD

(71) Applicant: Sony Corporation, Tokyo (JP)

(72) Inventor: Scott L. Vance, Staffanstorp (SE)

(21) Appl. No.: 14/484,391

(22) Filed: Sep. 12, 2014

(51) Int. Cl. H01Q 7/06; H01Q 1/24

(52) U.S. Cl. CPC H01Q 7/06; H01Q 1/243

(57) ABSTRACT

A wireless electronic device includes a multi-layer flexible printed circuit board with two or more openings. A ferrite extends through the two or more openings such that a portion of the ferrite is on a top surface of the multi-layer flexible printed circuit board and a portion of the ferrite is on a bottom surface, which is opposite the top surface of the multi-layer flexible printed circuit board.

### FIELD

The present inventive concepts generally relate to the field of wireless communications.

### BACKGROUND

Communication devices such as cell phones and other user equipment may include near field communication (NFC) circuits that can be used to communicate with external NFC circuits. NFC circuits may use specialized antenna characteristics for NFC antennas that are incorporated into these communication devices. Some antenna designs, however, may limit the use of circuitry or metal adjacent the antenna or may be difficult to manufacture.

### SUMMARY

Various embodiments of the present inventive concepts include a wireless electronic device that includes a multi-layer flexible printed circuit board with two or more openings therein. A ferrite may extend through the two or more openings such that a first portion of the ferrite is on a first surface of the multi-layer flexible printed circuit board and a second portion of the ferrite is on a second surface of the multi-layer flexible printed circuit board. The first surface of the multi-layer flexible printed circuit board may be opposite the second surface of the multi-layer flexible printed circuit board.

According to various embodiments, the ferrite may alternately extend through the two or more openings from the second surface of the multi-layer flexible printed circuit board to the first surface of the multi-layer flexible printed circuit board and then from the first surface of the multi-layer flexible printed circuit board to the second surface of the multi-layer flexible printed circuit board. Conductive traces may be included on the multi-layer flexible printed circuit board. The conductive traces may include a first loop section of one or more conductive traces around a first one of the openings in the multi-layer flexible printed circuit, board and a second loop section of one or more conductive traces around a second one of the openings in the multi-layer flexible printed circuit board. The conductive traces may be embedded in the first surface of the multi-layer flexible printed circuit board or in the second surface of the multi-layer flexible printed circuit board.

According to various embodiments, current flow in all of the one or more conductive traces of the first loop section may be in a first direction, where the first direction may be a clock-wise direction or a counter-clock-wise direction. The current flow in all of the one or more conductive traces of the second loop section may be in a second direction, where the second direction is a clock-wise direction or a counter-clock-wise direction. The first loop section may be adjacent to the second loop section, and the first direction may be opposite the second direction. The conductive traces that are on the first surface may be between the multi-layer flexible printed circuit board and the ferrite and have current flow that is in a same first direction. The conductive traces that are on the first surface may not be between the multi-layer flexible printed circuit board and the ferrite but may overlap a portion of the ferrite that is on the second surface have current flow that is in a same second direction. The first direction of current flow may be opposite the second direction of current flow. According to some embodiments, the ferrite and the first and second loop sections may provide multiple spaced-apart hotspots configured to provide near field communication (NFC).

The multi-layer flexible printed circuit board may include a first end and a second end that are spaced apart from each other and are spaced apart from the two or more openings. A display device may be near the first end of the multi-layer flexible printed circuit board. The display device may be between the first end and the second end of the multi-layer flexible printed circuit board where the first end and the second end may be opposite ends of the multi-layer flexible printed circuit board. A first hotspot that is configured to provide near field communication (NFC) may be located near the first end and a second hotspot that is configured to provide NFC may be located near the second end.

In some embodiments, a first edge of the display device may be near the first hotspot and a second edge of the display device may be near the second hotspot. The display device may overlap the multi-layer flexible printed circuit board between the first hotspot and the second hotspot. The wireless electronic device may include an armband that includes the display device and the multi-layer flexible printed circuit board.

According to various embodiments, a wireless electronic device may include a multi-layer flexible printed circuit board including two or more openings. A ferrite may extend through the two or more openings such that a first portion of the ferrite may be on a first surface of the multi-layer flexible printed circuit board and a second portion of the ferrite may be on a second surface of the multi-layer flexible printed circuit board. The first surface of the multi-layer flexible printed circuit board may be opposite the second surface of the multi-layer flexible printed circuit board. The multi-layer flexible printed circuit board may include conductive traces where the conductive traces include a first loop section of one or more conductive traces around a first one of the openings in the multi-layer flexible printed circuit board and a second loop section of one or more conductive traces around a second one of the openings in the multi-layer flexible printed circuit board. Some of the conductive traces may be on the first surface of the multi-layer flexible printed circuit board and other conductive traces may be on the second surface of the multi-layer flexible printed circuit board. The ferrite and the first and second loop sections may provide a first hotspot that is configured to provide near field communication (NFC). The first hotspot may be located near a first end of the multi-layer flexible printed circuit board and a second hotspot that is configured to provide NFC may be located near a second end of the multi-layer flexible printed circuit board. The first end and the second end of the multi-layer flexible printed circuit board may include opposite ends of the multi-layer flexible printed circuit board.

According to various embodiments, the first loop section may be adjacent to the second loop section. Current flow in all of the conductive traces of the first loop section may be in a first direction that is a clock-wise direction or a counter-clock-wise direction. Current flow in all of the conductive traces of the second loop section may be in a second direction that is a clock-wise direction or a counter-clock-wise direction. The first direction may be opposite in direction from the second direction. Some of the conductive traces that are on the first surface may be between the multi-layer flexible printed circuit board and the ferrite. The conductive traces may have current flow that is in a same third direction. Some of the conductive traces that are on the first surface may not be between the multi-layer flexible printed circuit board and the ferrite but overlap a portion of the ferrite that is on the second surface. These conductive traces may have a current flow that is in a same fourth direction. The third direction may be opposite in direction from the fourth direction.

According to various embodiments, the wireless electronic device may include an armband that includes a display device and the multi-layer flexible printed circuit board. The display device may be between the first end and the second end of the multi-layer flexible printed circuit board. A first edge of the display device may be near a first hotspot and a second edge of the display device may be near a second hotspot. The display device may overlap the multi-layer flexible printed circuit board between the first hotspot and the second hotspot.

According to various embodiments, the ferrite may be woven through the two or more openings in the multi-layer flexible printed circuit board such that the ferrite alternates between the first surface and the second surface of the multi-layer flexible printed circuit board.

According to various embodiments, a wireless electronic device may include a multi-layer printed circuit board including two or more openings. A flexible magnetic material may extend through the two or more openings such that a first portion of the flexible magnetic material may be on a first surface of the multi-layer printed circuit board and a second portion of the flexible magnetic material may be on a second surface of the multi-layer printed circuit board. The first surface of the multi-layer printed circuit board may be opposite the second surface of the multi-layer printed circuit board.

Other devices according to embodiments of the inventive concepts will be or become apparent to one with skill in the art upon review of the following drawings and detailed description. It is intended that all such additional devices be included within this description, be within the scope of the present inventive concepts, and be protected by the accompanying claims. Moreover, it is intended that all embodiments disclosed herein can be implemented separately or combined in any way and/or combination.

### BRIEF DESCRIPTION OF THE DRAWINGS

FIG. 1 illustrates a diagram of a multi-layer flexible printed circuit board of a wireless electronic device, according to various embodiments of the present inventive concepts.

FIG. 2 illustrates a diagram of a multi-layer flexible printed circuit board with a ferrite of a wireless electronic device, according to various embodiments of the present inventive concepts.

FIG. 3 illustrates directions of current flow on a multi-layer flexible printed circuit board with a ferrite of a wireless electronic device, according to various embodiments of the present inventive concepts.

FIGS. 4A-4C illustrate diagrams of a multi-layer flexible printed circuit board and an adjacent display, according to various embodiments of the present inventive concepts.

FIG. 5 illustrates a block diagram of a wireless electronic device of any of FIGS. 1-4C, according to various embodiments of the present inventive concepts.

### DETAILED DESCRIPTION

The present inventive concepts now will be described more fully with reference to the accompanying drawings, in which embodiments of the inventive concepts are shown. However, the present application should not be construed as limited to the embodiments set forth herein. Rather, these embodiments are provided so that this disclosure will be thorough and complete, and to fully convey the scope of the embodiments to those skilled in the art. Like reference numbers refer to like elements throughout.

The terminology used herein is for the purpose of describing particular embodiments only and is not intended to be limiting of the embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to another element, it can be directly coupled, connected, or responsive to the other element, or intervening elements may also be present. In contrast, when an element is referred to as being “directly coupled,” “directly connected,” or “directly responsive” to another element, there are no intervening elements present. As used herein, the term “and/or” includes any and all combinations of one or more of the associated listed items.

Spatially relative terms, such as “above,” “below,” “upper,” “lower,” “top,” “bottom,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly. Well-known functions or constructions may not be described in detail for brevity and/or clarity.

It will be understood that, although the terms “first,” “second,” etc. may be used herein to describe various elements, these elements should not be limited by these terms. These terms are only used to distinguish one element from another. Thus, a first element could be termed a second element without departing from the teachings of the present embodiments.

Unless otherwise defined, all terms (including technical and scientific terms) used herein have the same meaning as commonly understood by one of ordinary skill in the art to which these embodiments belong. It will be further understood that terms, such as those defined in commonly-used dictionaries, should be interpreted as having a meaning that is consistent with their meaning in the context of the relevant art and will not be interpreted in an idealized or overly-formal sense unless expressly so defined herein.

Wireless electronic devices may include one or more antennas for various types of communication. It may be generally desired for antennas to be low cost and easy to manufacture. For example, antenna designs may use an antenna that is at least partially free of overlap by other metallic elements. Moreover, antenna designs may have a single “hotspot”. As used herein, a hotspot may be an area on or near an antenna where the antenna may receive/transmit signals from/to a complementary device. The hotspot may include a concentration of electromagnetic fields where the field strength is stronger relative to other areas around the antenna.

Various embodiments of the present inventive concepts, however, may provide an antenna that includes multiple hotspots that are spaced apart from one another. Moreover, various embodiments of the present inventive concepts may provide an electromagnetic field that is on or near to the antenna structure such that other metallic elements may overlap the device and/or structure. As used herein, a wireless electronic device may include mobile phones, tablets, handheld devices, armband devices, and/or smartwatches. As also used herein, “flexible” means a structure that is not rigid. In specific examples of materials used herein, glass is considered to be rigid, whereas ferrite may be considered to be flexible. As also used herein, a “rigid” structure is a stiff structure that is unable to bend or be forced out of shape; i.e., not flexible or pliant. A rigid structure may be subject to minimal bending without breaking, but bending beyond this minimal bending will break or deform a rigid structure. Finally, as used herein, a “sheet” means a broad, relatively thin piece, plate or slab of material.

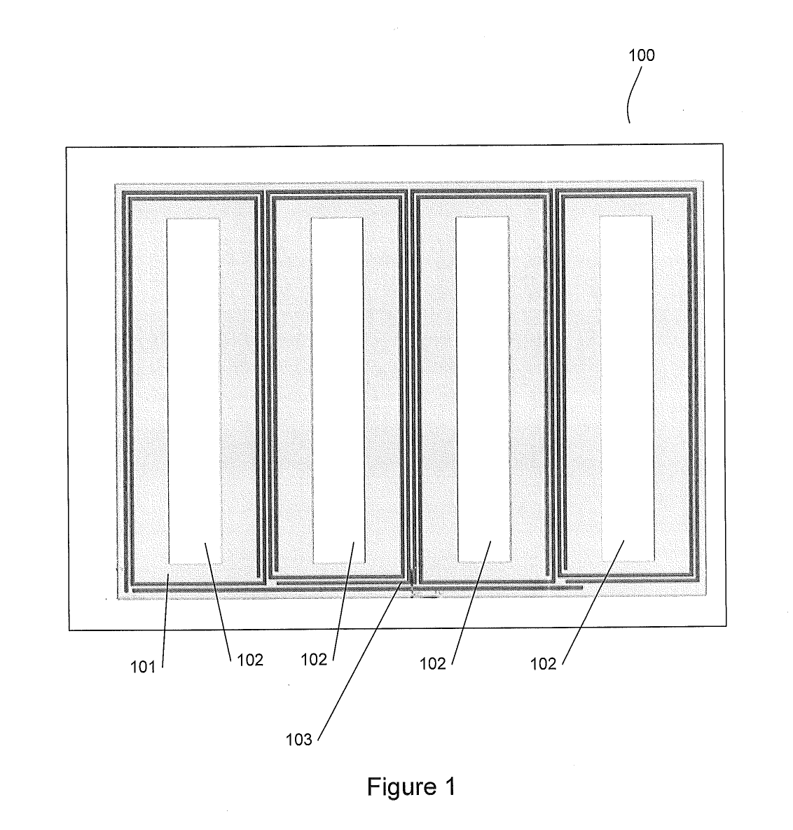

Referring now to FIG. 1, a diagram illustrates a wireless electronic device 100 that includes a multi-layer flexible printed circuit board 101 with two or more openings 102. The openings 102 may be holes that are void of the multi-layer flexible printed circuit board 101. As used herein, a “multi-layer” printed circuit board is a printed circuit board that may support two or more layers of conductive traces. For example, a two-layer printed circuit board may support traces on the top and the bottom of the printed circuit board. A three-layer printed circuit board may support traces on the top, the bottom, and on/in an intermediate layer of the printed circuit board. The multi-layer flexible printed circuit board 101 may be a two-layer board that is about 20×35 millimeters (mm) in size, but those skilled in the art will appreciate that it may be larger or smaller, depending on the desired electromagnetic field characteristics and/or desired locations of hotspots. Although a multi-layer flexible printed circuit board 101 is discussed by way of example, other types of printed circuit boards, wiring boards, and/or substrates may be used in some embodiments.

Still referring to FIG. 1, the perimeter of each opening 102 may be, for example, rectangular or square in shape but other shapes may be used. Manufacturing of the openings 102 may be easier for a shape of the openings 102 that includes straight edges. The orientation of the openings 102 relative to the multi-layer flexible printed circuit board 101 is illustrated in FIG. 1, for example, with the edges of the openings 102 parallel to edges of the multi-layer flexible printed circuit board 101. However, other orientations of the openings 102 may be used to change electromagnetic field characteristics and/or the locations of hotspots.

Still referring to FIG. 1, conductive traces 103 may be on the multi-layer flexible printed circuit board 101. The conductive traces 103 may be included on both sides of a two-layer flexible printed circuit board and/or may be included in intermediate layers in multi-layer flexible printed circuit boards 101 with more than two layers. Conductive traces 103 on multiple layers allow for traces to cross one another without forming a short circuit. The conductive traces 103 may include loops around the perimeter of the openings 102. Current may flow through these loops. The conductive traces 103 may be embedded within the multi-layer flexible printed circuit board 101 or be on a surface of the multi-layer flexible printed circuit board 101. For example, the conductive traces 103 may be on a first surface and/or a second surface of the multi-layer flexible printed circuit board 101. The first surface and second surface of the multi-layer flexible printed circuit board 101 may be opposite one another. As an example, conductive traces 103 may be on a top surface of the multi-layer flexible printed circuit board 101 and/or on a bottom surface of the multi-layer flexible printed circuit board 101.

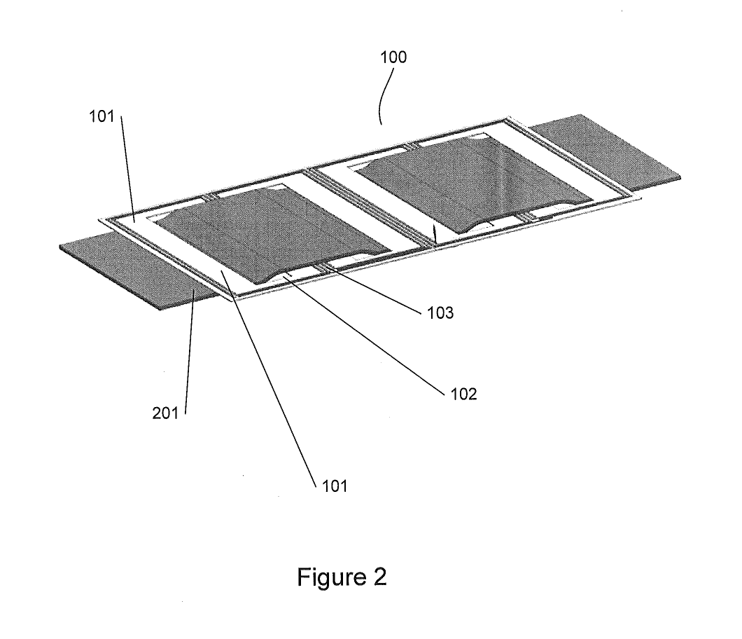

Reference is now made to FIG. 2, which illustrates the wireless electronic device 100 of FIG. 1. A ferrite 201 extends through at least two of the openings 102 of the multi-layer flexible printed circuit board 101. According to some embodiments, the ferrite 201 may be a flexible ferrite sheet. According to some embodiments, the ferrite may be a rigid ferrite that is cracked into small grids and placed on a carrier for support. The rigid ferrite on the carrier may behave in a flexible manner even though individual sections of the ferrite grid are rigid. This rigid ferrite on a carrier with cracks in a grid may extend through the openings 102 of the multi-layer flexible printed circuit board 101.

The ferrite may be of any shape, although a rectangular shape is shown for illustrative purposes. The ferrite may be, for example, about 8-10 mm in width and about 20-40 mm in length. Larger ferrite 201 sizes may provide better performance. Larger ferrite 201 sizes compared to the overall size of the structure may assist in reducing overlap of fields. Overlapping fields may provide cancellation of fields that may reduce performance of the overall antenna structure. The size of the ferrite 201 may be limited by the amount of space needed for the conductive traces 103 along the side of the openings 102 on the multi-layer flexible printed circuit board 101. Each opening 102 in the multi-layer flexible printed circuit board 101 may be large enough to allow the ferrite 201 to pass through. For example, each opening 102 may be 0.2 mm wider than the width of the ferrite 201. Each opening 102 may be wide enough to allow the multi-layer flexible printed circuit board 101 to lie flat. In some embodiments, the ferrite 201 may lie flat while the multi-layer flexible printed circuit board 101 may bend to support the configuration. In some embodiments, there may be some bending of the multi-layer flexible printed circuit board 101 and some bending of the ferrite 201.

In some embodiments, to limit tearing of the multi-layer flexible printed circuit board 101 during insertion of the ferrite 201, relief cut-outs may be provided in the corners or other locations of the openings 102 in the multi-layer flexible printed circuit board 101. For example, an opening 102 with relief cut-outs may be shaped like a dog bone.

While the ferrite 201 is described in the present application for illustrative purposes, the ferrite 201 may be replaced with any flexible magnetic material. The flexible magnetic material may have properties such as a high permeability, μ′, and low loss, μ″. Use of a multi-layer flexible printed circuit board 101 with an interwoven ferrite 201 may allow for manufacture without soldering since the ferrite 201 does not need to be electrically connected to the multi-layer flexible printed circuit board 101. The ferrite 201 may extend between ends of the multi-layer flexible printed circuit board 101. In some embodiments, the ferrite 201 may extend beyond the ends of the multi-layer flexible printed circuit board 101 or may not entirely extend to the edges of the multi-layer flexible printed circuit board 101.

Still referring to FIG. 2, the ferrite 201 may extend such that a first portion of the ferrite 201 is on a first surface of the multi-layer flexible printed circuit board 101 and a second portion of the ferrite 201 is on a second surface of the multi-layer flexible printed circuit board 101. In other words, the ferrite 201 is woven through the openings 102 in the multi-layer flexible printed circuit board 101, alternating between the top surface and bottom surface of the multi-layer flexible printed circuit board 101.

The multi-layer flexible printed circuit board 101 with the ferrite 201 and conductive traces 103 forming loops may function as a Near Field Communication (NFC) antenna, NFC may be used for swiping proximity payments, information exchange at small distances, and/or for simplified setup of devices such as Wi-Fi or Bluetooth devices. NFC may be used to share contact information by touching smartphones or bringing them within close proximity of one another such as within ten centimeters. Communication may also be possible between an NFC device and an unpowered NFC chip, called a tag (for example, RFID tag).

NFC circuits may communicate via magnetic field induction and/or near field coupling. An NFC circuit including the multi-layer flexible printed circuit board 101 with the ferrite 201 and conductive traces 103 forming loops may be placed in close proximity to another antenna's near field transceiver, thereby effectively forming an air-core transformer. Information may be sent between NFC devices based on disturbances in the magnetic field. Some embodiments of the NFC circuits can transmit within the globally available and unlicensed radio frequency ISM band of 13.56 MHz, with a bandwidth of almost 2 MHz. Some embodiments of the NFC circuits can support data rates of 106, 212, or 424 kbit/s using a modified Miller coding or Manchester coding to encode and decode communicated data. In some embodiments, NFC circuits may be passively powered. Moreover, in some embodiments, other types of short-range communication such as Wi-Fi or Bluetooth may be provided instead of NFC, using the multi-layer flexible printed circuit board 101 with the ferrite 201 and conductive traces 103.

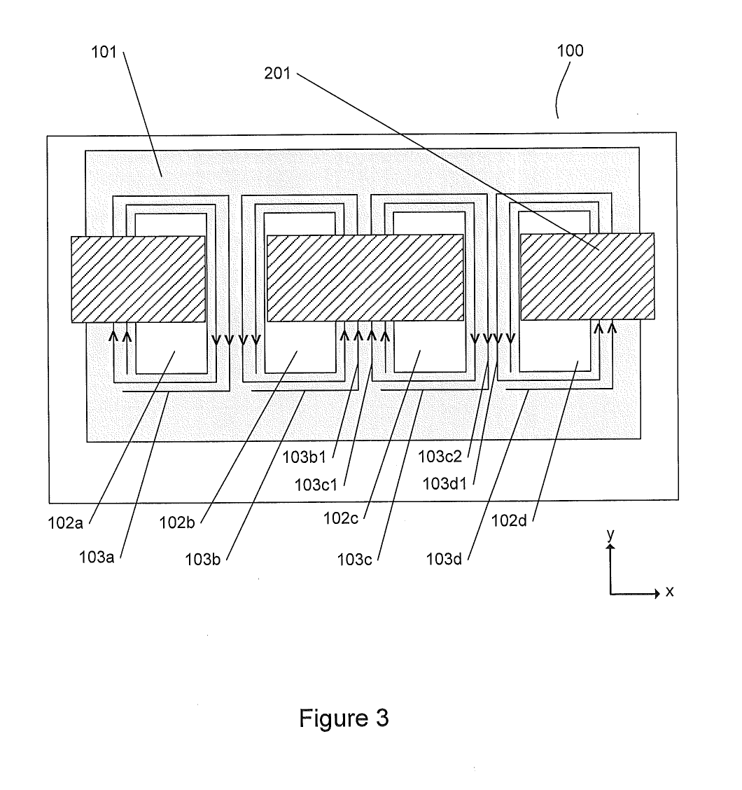

Referring now to FIG. 3, conductive traces 103 of FIGS. 1 and 2 may form loop sections 103a, 103b, 103c, and 103d. Each loop section formed by the conductive traces 103 may include one or more turns of the conductive traces 103. Although three turns per loop section are illustrated as an example in FIG. 3, any number of turns per each loop section may be used. The number of turns per loop section may be dependent on the characteristics of the NFC circuitry and/or chips used in conjunction with the loop antenna structure, features of the ferrite 201 such as the permeability, size of the structure, self-resonating frequency, and/or the desired impedance characteristics. For example, a smaller sized multi-layer flexible printed circuit board 101 may include a larger number of turns per loop, when compared to a larger multi-layer flexible printed circuit board 101. The number of loops and the spacing between loops may affect the overall performance and characteristics of the electromagnetic field around the device 100.

Still referring to FIG. 3, although four loop sections are illustrated for discussion, the described functionality may be achieved by two or more loop sections. As an example, two loop sections 103b and 103c of the conductive traces 103, will now be discussed in greater detail. A first loop section 103b may include one or more conductive traces around a first opening 102b in the multi-layer flexible printed circuit board 101. A second loop section 103c may include one or more conductive traces around a second opening 102c in the multi-layer flexible printed circuit board 101. Current may flow in all or some of the traces in the first loop section 103b and/or in the second loop section 103c. The direction of current flow in each of the loop sections may be clockwise or counter-clockwise, with respect to the opening.

In some embodiments described herein, the first loop section 103b may be adjacent the second loop section 103c. The direction of current flow in a given loop section may be opposite in direction to the direction of current flow in an adjacent loop section. For example, the direction of current flow in loop section 103b may be opposite in direction to the direction of current flow in loop section 103c. In other words, if the current flow in loop section 103b is in a counter-clockwise direction, as illustrated in FIG. 3, the current flow in loop section 103c, which is adjacent loop section 103b, would be in a clockwise direction while the current flow in loop section 103a, which is also adjacent loop section 103b, would be in a clockwise direction.

Still referring to FIG. 3, conductive traces 103 in a direction y, that are on the top surface between the multi-layer flexible printed circuit board 101 and the ferrite 201, where the ferrite 201 overlaps the multi-layer flexible printed circuit board 101, may all have current flow in the same direction. For example, the current in traces 103b1 and 103c1 may be in the same direction, with respect to the multi-layer flexible printed circuit board 101. Similarly, conductive traces 103 that are on the top surface of the multi-layer flexible printed circuit board 101 but are not between the multi-layer flexible printed circuit board 101 and the ferrite 201 in a direction y, but overlap a portion of the ferrite 201 may all have current flow in a same direction. For example, the current in traces 103c2 and 103d1 may be in the same direction, with respect to the multi-layer flexible printed circuit board 101.

In some embodiments, a single sided flexible printed circuit board 101 may be used. A single sided flexible printed circuit board 101 may include one conductive trace 103 between each opening 102. The ferrite 201 may be woven through the openings 102. The resulting device 100 would effectively result in a looping of conductive traces 103 around the ferrite (i.e. a zigzag pattern).

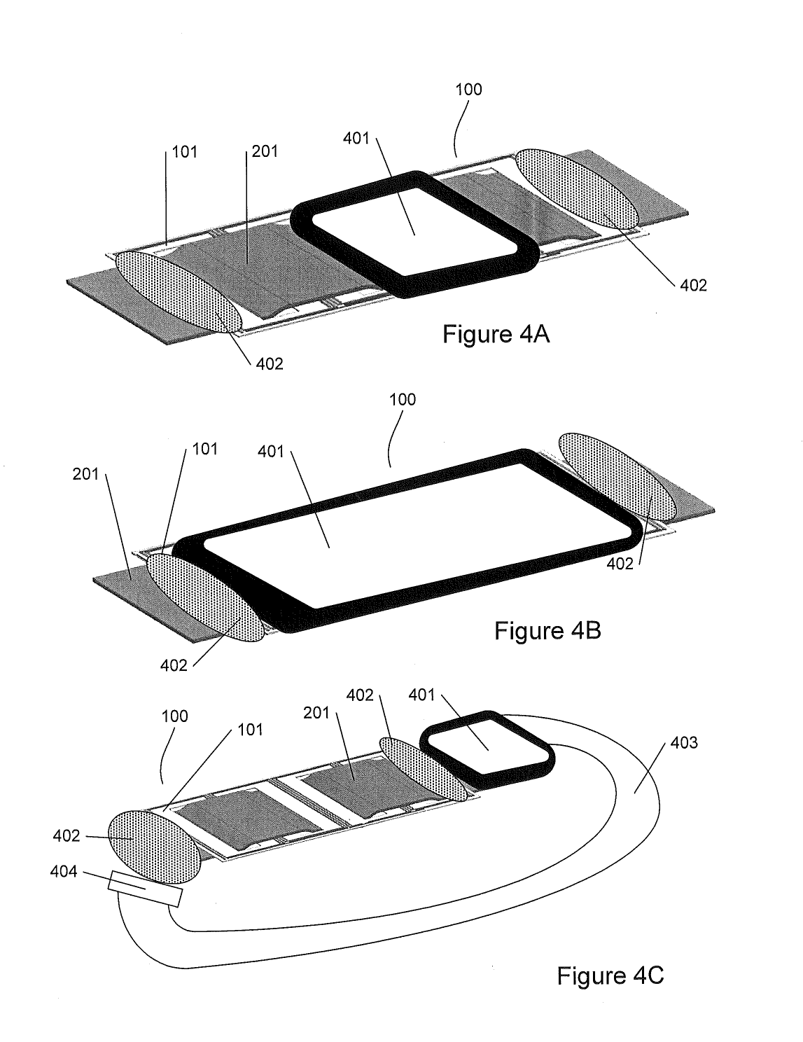

FIGS. 4A-4C illustrate diagrams of a multi-layer flexible printed circuit board and a display. Referring now to FIG. 4A, a display 401 may overlap the ferrite 201 and/or the multi-layer flexible printed circuit board 101. The display 401 may be part of and/or include functionality of wireless electronic devices such as mobile phones, tablets, and/or smartwatches. The display 401 may be located between the ends of the multi-layer flexible printed circuit board 101. The ferrite 201 and the conductive traces 103 arranged in loop sections may provide multiple hotspots 402 at, near, or on the wireless electronic device 100. These hotspots may be configured to provide near field communication (NFC).

In some embodiments, the multiple hotspots 402 may be spaced apart from each other. For example the hotspots may be located near opposite ends of the multi-layer flexible printed circuit board 101. The display 401 may be located between the hotspots 402.

Referring now to FIG. 4B, the display 401 may be positioned such that the multiple hotspots 402 are near the edges of the display 401. The multiple spaced-apart hotspots 402 located near ends of the multi-layer flexible printed circuit board 101 may provide an advantage since the ferrite 201, openings 102, and/or conductive traces 103 may be overlapped by the display 401 and/or by other circuitry that provides functionality of mobile phones, tablets, and/or smartwatches. Magnetic deadspots, where the NFC fields are weak, may be present directly above or below the multi-layer flexible printed circuit board 101. In some embodiments, the location of the display 401 may correspond to the location of a deadspot. The described arrangement of the ferrite 201, openings 102, and/or conductive traces 103 may allow the electromagnetic field to be contained close to the ferrite 201, near the ends of the device 100. The field related to the device 100 may be directional, thereby providing greater field concentration in a given direction. These directional fields would allow the wireless electronic device 100 to be placed between conductors in a mechanical stack, as long as the ends of the ferrite are sufficiently exposed to provide access the hotspots 402.

Referring now to FIG. 4C, the display 401 may be located near one hotspot 402. The wireless electronic device 100 may be incorporated with an armband 403 that may extend from the display 401 and/or one end of the multi-layer flexible printed circuit board 101 to another end of the multi-layer flexible printed circuit board 101. The armband 403 may be a wristband or watch, in some embodiments. A printed circuit board that is flexible may be incorporated with an armband 403 such that it may contour to an arm, wrist, or other body part of a user. The armband 403 may overlap or cover at least a portion of the wireless electronic device 100.

Still referring to FIG. 4C, a clasp 404 may be attached to the armband 403. The clasp 404 may be a fastener that may be used by a user to secure the armband 403. The clasp 404 may be a marker or detection area for NFC. A hotspot 402 may be located near or on the clasp 404. The multiple spaced-apart hotspots 402 may provide a device 100 that has multiple areas where NFC may be detected. These multiple hotspots 402 may be useful, for example, when a user wears the armband 403 on or near the wrist and is able to detect NFC near the display 401 and/or near the clasp 404. In other words, a wearer of the device 100 may use either the top or the bottom surface of the device 100 for NFC. This would allow the hotpots 402 to be near the front or the back of the wearer's hand.

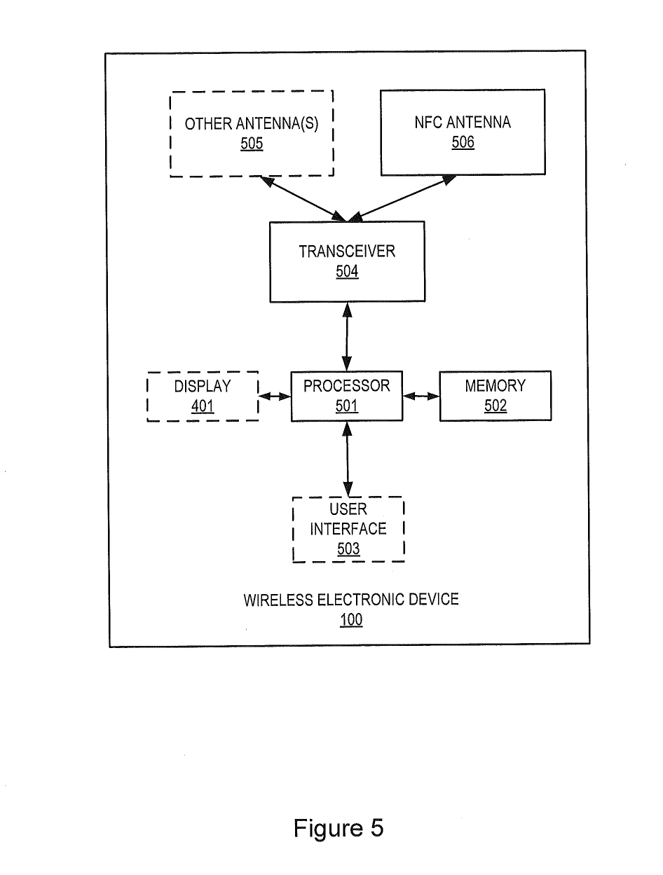

Referring now to FIG. 5, a block diagram of a wireless electronic device 100 of any of FIGS. 1-4C is provided. As illustrated in FIG. 5, the wireless electronic device 100 may include a processor (e.g., processor circuit) 501, memory 502, a transceiver 504, and/or an NFC or other short-range antenna 506. Moreover, the wireless electronic device 100 may optionally include a user interface 503, a display 401 (for example, display 401 discussed above with respect to FIGS. 4A-4C), and/or other antenna(s) 505. In some embodiments, the NFC antenna 506 may include the multi-layer flexible printed circuit board 101 with openings 102 and conductive traces 103, as illustrated in any of FIGS. 1-4C. Although NFC is discussed by way of example, the concepts/antennas described herein may be applied to other over-the-air wireless communications (e.g., cellular wireless communications, Wi-Fi, Bluetooth, etc.).

Various embodiments of the inventive concepts described herein may arise from the recognition that simpler, lower cost manufacturing of antennas may be desired. Reference is made to U.S. Pat. No. 8,638,268, to Murata Manufacturing Co., Ltd. (hereinafter “Murata”) and Japanese Publication No. 2013-138345, to Panasonic Corp., (hereinafter “Panasonic”), each of which are hereby incorporated by reference. When compared to the structures of Murata and Panasonic, the wireless electronic device 100 described herein may be lower in cost and easier to manufacture. Specifically, the antenna of Panasonic may require two flexible films that are soldered together. Manufacturing of this device may be difficult since positioning of the ferrite between the flexible films may require precision with low tolerance for misalignment. Additionally position of the loops in the Panasonic device may also require low tolerance for misalignment. As such, the wireless electronic device 100 described herein may be easier to manufacture and be lower in cost since soldering may not be required.

When compared to the device of Murata, the wireless electronic device 100 described herein may include more uniform loops around the ferrite 201. Uniform loops may provide a more directional field, which in turn may allow for the structure to be placed between conductors, if needed for a given application. Moreover, the wireless electronic device 100 described herein includes fewer loops on the side of the ferrite 201 when compared to the device of Murata. The fewer loop on the side of the ferrite 201 may allow for use of wider ferrite 201, providing improvement in overall device performance.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of all combinations and subcombinations of the embodiments described herein, and of the manner and process of making and using them, and shall support claims to any such combination or subcombination.

In the drawings and specification, there have been disclosed various embodiments and, although specific terms are employed, they are used in a generic and descriptive sense only and not for purposes of limitation.

What is claimed is:

1. A wireless electronic device comprising:
a multi-layer flexible printed circuit board comprising two or more openings therein; and
a ferrite that extends through the two or more openings such that a first portion of the ferrite is on a first surface of the multi-layer flexible printed circuit board and a second portion of the ferrite is on a second surface of the multi-layer flexible printed circuit board,
wherein the first surface of the multi-layer flexible printed circuit board is opposite the second surface of the multi-layer flexible printed circuit board.

2. The wireless electronic device of claim 1, wherein the ferrite alternately extends through the two or more openings from the second surface of the multi-layer flexible printed circuit board to the first surface of the multi-layer flexible printed circuit board and then from the first surface of the multi-layer flexible printed circuit board to the second surface of the multi-layer flexible printed circuit board.

3. The wireless electronic device of claim 1, further comprising:
conductive traces on the multi-layer flexible printed circuit board, the conductive traces comprising a first loop section of one or more conductive traces around a first one of the openings in the multi-layer flexible printed circuit board and a second loop section of one or more conductive traces around a second one of the openings in the multi-layer flexible printed circuit board.

4. The wireless electronic device of claim 3, wherein the conductive traces are embedded in the first surface of the multi-layer flexible printed circuit board and/or in the second surface of the multi-layer flexible printed circuit board.

5. The wireless electronic device of claim 3,
wherein current flow in all of the one or more conductive traces of the first loop section is in a first direction, wherein the first direction is a clock-wise direction or a counter-clock-wise direction, and
wherein current flow in all of the one or more conductive traces of the second loop section is in a second direction, wherein the second direction is a clock-wise direction or a counter-clock-wise direction.

6. The wireless electronic device of claim 5,
wherein the first loop section is adjacent to the second loop section, and
wherein the first direction is opposite the second direction.

7. The wireless electronic device of claim 3, wherein ones of the conductive traces that are on the first surface and are between the multi-layer flexible printed circuit board and the ferrite have current flow that is in a same first direction.

8. The wireless electronic device of claim 7, wherein ones of the conductive traces that are on the first surface and are not between the multi-layer flexible printed circuit board and the ferrite but overlap a portion of the ferrite that is on the second surface have current flow that is in a same second direction.

9. The wireless electronic device of claim 8, wherein the first direction is opposite the second direction.

10. The wireless electronic device of claim 3, wherein the ferrite and the first and second loop sections provide multiple spaced-apart hotspots configured to provide near field communication (NFC).

11. The wireless electronic device of claim 1,
wherein the multi-layer flexible printed circuit board comprises a first end and a second end that are spaced apart from each other and are spaced apart from the two or more openings, and
wherein a display device is near the first end of the multi-layer flexible printed circuit board.

12. The wireless electronic device of claim 11,
wherein the display device is between the first end and the second end of the multi-layer flexible printed circuit board,
wherein the first end and the second end comprise opposite ends of the multi-layer flexible printed circuit board.

13. The wireless electronic device of claim 12, wherein a first hotspot that is configured to provide near field communication (NFC) is located near the first end and a second hotspot that is configured to provide NFC is located near the second end.

14. The wireless electronic device of claim 13, wherein a first edge of the display device is near the first hotspot and a second edge of the display device is near the second hotspot.

15. The wireless electronic device of claim 14, wherein the display device overlaps the multi-layer flexible printed circuit board between the first hotspot and the second hotspot.

16. The wireless electronic device of claim 15, wherein the wireless electronic device comprises an armband comprising the display device and the multi-layer flexible printed circuit board.

17. The wireless electronic device of claim 1, wherein the ferrite is woven through the two or more openings in the multi-layer flexible printed circuit board such that the ferrite alternates between the first surface and the second surface of the multi-layer flexible printed circuit board.

18. A wireless electronic device comprising:
a multi-layer flexible printed circuit board comprising two or more openings therein;
a ferrite that extends through the two or more openings such that a first portion of the ferrite is on a first surface of the multi-layer flexible printed circuit board and a second portion of the ferrite is on a second surface of the multi-layer flexible printed circuit board, wherein the first surface of the multi-layer flexible printed circuit board is opposite the second surface of the multi-layer flexible printed circuit board; and
conductive traces on the multi-layer flexible printed circuit board, the conductive traces comprising a first loop section of one or more conductive traces around a first one of the openings in the multi-layer flexible printed circuit board and a second loop section of one or more conductive traces around a second one of the openings in the multi-layer flexible printed circuit board,
wherein first ones of the conductive traces are on the first surface of the multi-layer flexible printed circuit board and second ones of the conductive traces are on the second surface of the multi-layer flexible printed circuit board,
wherein the ferrite and the first and second loop sections provide a first hotspot that is configured to provide near field communication (NFC) and is located near a first end of the multi-layer flexible printed circuit board and a second hotspot that is configured to provide NFC and is located near a second end of the multi-layer flexible printed circuit board, and
wherein the first end and the second end comprise opposite ends of the multi-layer flexible printed circuit board.

19. The wireless electronic device of claim 18,
wherein the first loop section is adjacent to the second loop section,
wherein current flow in all of the one or more conductive traces of the first loop section is in a first direction that is a clock-wise direction or a counter-clock-wise direction,
wherein current flow in all of the one or more conductive traces of the second loop section is in a second direction that is a clock-wise direction or a counter-clock-wise direction,
wherein the first direction is opposite in direction from the second direction,
wherein ones of the conductive traces that are on the first surface and are between the multi-layer flexible printed circuit board and the ferrite have current flow that is in a same third direction,
wherein ones of the conductive traces that are on the first surface and are not between the multi-layer flexible printed circuit board and the ferrite but overlap a portion of the ferrite that is on the second surface have current flow that is in a same fourth direction,
wherein the third direction is opposite in direction from the fourth direction.

20. The wireless electronic device of claim 18,
wherein the wireless electronic device comprises an armband comprising a display device and the multi-layer flexible printed circuit board,
wherein the display device is between the first end and the second end of the multi-layer flexible printed circuit board,
wherein a first edge of the display device is near the first hotspot and a second edge of the display device is near the second hotspot,
wherein the display device overlaps the multi-layer flexible printed circuit board between the first hotspot and the second hotspot.

21. A wireless electronic device comprising:
a multi-layer printed circuit board comprising two or more openings therein; and
a flexible magnetic material that extends through the two or more openings such that a first portion of the flexible magnetic material is on a first surface of the multi-layer printed circuit board and a second portion of the flexible magnetic material is on a second surface of the multi-layer printed circuit board,
wherein the first surface of the multi-layer printed circuit board is opposite the second surface of the multi-layer printed circuit board.
